(19) United States
(12) Patent Application Publication
(10) Pub. No.: US 2013/0241524 A1
(43) Pub. Date: Sep. 19, 2013

(54) BAND GAP REFERENCE CIRCUIT

(71) Applicant: Fumihiro INOUE, Tokyo (JP)

(72) Inventor: Fumihiro INOUE, Tokyo (JP)

(21) Appl. No.: 13/774,008

(22) Filed: Feb. 22, 2013

(30) Foreign Application Priority Data
Mar. 14, 2012 (JP) 2012-057886

(51) Int. Cl. G05F 3/02

(52) U.S. Cl. CPC G05F 3/02
USPC 323/313

(57) ABSTRACT

A band gap reference circuit includes an output circuit configured to output a reference voltage based on a reference current generated by a voltage difference between a forward voltage of a PN junction of a first semiconductor device and a forward voltage of a PN junction of a second semiconductor device, and a adder/subtractor circuit configured to add or subtract a correction current with respect to the reference current.

### BACKGROUND OF THE INVENTION

1. Field of the Invention

The present invention generally relates to a band gap reference circuit, such as a band gap reference circuit for outputting a reference voltage based on thermal voltage.

2. Description of the Related Art

FIG. 1 is a schematic diagram illustrating a configuration of a band gap reference circuit 10 according to a related art example. With the configuration illustrated in FIG. 1, the current density of a transistor Q12 becomes 1/(m·n) in a case where the proportion (ratio) of the number of transistors between Q11 and Q12 (Q11:Q12) is set to 1:n, and the proportion (ratio) of the resistance between R11 and R12 (R11:R12) is set to 1:m. As a result, the following Formula (1) is obtained.

VBE1−VBE2=Vt·1n (m·n) (1)

In Formula (1), “VBE1” indicates the voltage between the base and the emitter of the transistor Q11, “VBE2” indicates the voltage between the base and the emitter of the transistor Q12, and “Vt” (=k·T/q) indicates the thermal voltage of the transistors Q11, Q12. “k” (=1.38×10⁻²³) indicates the Boltzmann constant, “T” indicates the absolute temperature, and “q” (=1.602×10⁻¹⁹). For example, the thermal voltage is approximately 25.7 mV when the temperature is 25° C.

In a case where a resistor R10 receives VBE1−VBE2, a current I12 flowing in the transistor Q12 is expressed with the following Formula (2), and a current I11 flowing in the transistor Q11 is expressed with the following Formula (3).

I12=Vt·1n (m·n)/R10 (2)

I11=m·I12 (3)

VBE1−VBE2 is a voltage having a positive (+) thermal coefficient, and a voltage having a positive thermal characteristic is generated in the resistors R11, R12 that receive the current generated by the VBE1−VBE2 and the resistor R10. The thermal characteristic of the forward voltage of a diode (i.e. the forward voltage of a PN junction between the base and the emitter of the transistors Q11, Q12 that are connected to a diode) is negative, and the thermal characteristic of the voltage generated at the resistors R11, R12 is positive. Accordingly, a band gap reference voltage that exhibits little thermal dependency can be output from an operational amplifier 11 by selecting the resistors R11, R12 having the same absolute temperature coefficient.

However, there may be a case where the thermal dependency of the band gap reference voltage increases due to inconsistency of the resistance value of a resistor or the saturation current of a transistor caused by inconsistent manufacturing. In this case where the thermal dependency of the band gap reference voltage increases, Japanese Laid-Open Patent Publication No. 11-121694 discloses a technology for minimizing the thermal dependency of the band gap reference voltage VBG. This technology can change the current value of the current flowing in the resistor by cutting off a fuse element by laser radiation, so that the thermal dependency of the band gap reference voltage VBG can be minimized.

However, only the current flowing in the resistor connected to the fuse element can be reduced with the above-described technology of cutting the fuse element. Therefore, it is difficult to make slight adjustments for the size of the band gap reference voltage.

### SUMMARY OF THE INVENTION

The present invention may provide a band gap reference circuit that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a band gap reference circuit particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a band gap reference circuit including an output circuit configured to output a reference voltage based on a reference current generated by a voltage difference between a forward voltage of a PN junction of a first semiconductor device and a forward voltage of a PN junction of a second semiconductor device; and a adder/subtractor circuit configured to add or subtract a correction current with respect to the reference current.

Other objects and further features of the present invention will be apparent from the following detailed description when read in conjunction with the accompanying drawings.

### BRIEF DESCRIPTION OF THE DRAWINGS

FIG. 1 is a schematic diagram illustrating a configuration of a band gap reference circuit 10 according to a related art example;

FIG. 2 is a schematic diagram illustrating a configuration of a band gap reference circuit according to the first embodiment of the present invention;

FIG. 3 is a schematic diagram illustrating a configuration of a band gap reference circuit according to the second embodiment of the present invention;

FIG. 4 is a schematic diagram illustrating a configuration of an operational amplifier according to an embodiment of the present invention;

FIG. 5 is a schematic diagram illustrating an example of a configuration of a reference voltage generation circuit according to an embodiment of the present invention;

FIG. 6 is a schematic diagram illustrating an example of a configuration of a correction circuit according to an embodiment of the present invention; and

FIG. 7 is a schematic diagram illustrating an example of a configuration of a startup circuit according to an embodiment of the present invention.

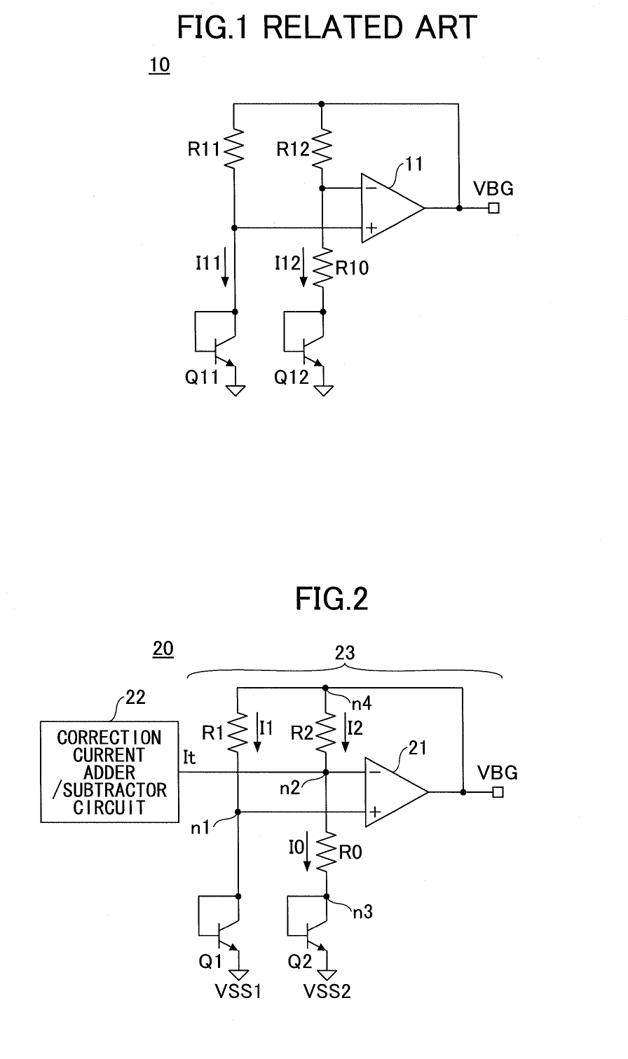

### DESCRIPTION OF THE PREFERRED EMBODIMENTS

In the following, embodiments of the present invention will be described with reference to the accompanying drawings. In the accompanying drawings, a transistor having a gate marked with a circle is a P channel type MOSFET whereas a transistor having a gate without a circle is a N channel type MOSFET.

FIG. 2 is a schematic diagram illustrating a configuration of a band gap reference circuit 20 according to the first embodiment of the present invention. As described below, the band gap reference circuit 20 utilizes a positive temperature characteristic exhibited by a voltage difference between a forward voltage of a PN junction of a first semiconductor device and a forward voltage of a PN junction of a second semiconductor device and a negative temperature characteristic exhibited by a forward voltage of a PN junction in which a reference current is generated by the aforementioned voltage difference. By utilizing the positive and negative temperature characteristics, the band gap reference circuit 20 can generate a band gap reference voltage VBG as a reference voltage which does not depend on temperature.

The band gap reference circuit 20 includes a reference voltage generation circuit 23 and a correction current adder/subtractor circuit 22 (hereinafter also referred to as “correction circuit 22”). It is to be noted that the term “correction” may also be referred to as “trimming”.

The reference voltage generation circuit 23 includes first and second semiconductor devices that are operated with current densities that are different from each other. In this embodiment, the first and second semiconductor devices are transistors Q1 and Q2. The reference voltage generation circuit 23 is a circuit that outputs a band gap reference voltage VBG based on a reference current I0. The reference current I0 is generated by the voltage difference between a forward voltage of a PN junction between the base and the emitter of the transistor Q1 and a forward voltage of a PN junction between the base and the emitter of the transistor Q2. The correction circuit 22 is a circuit that adds or subtracts a correction current It with respect to the reference current I0.

Accordingly, with the reference voltage generation circuit 23 having the above-described configuration, the correction current It not only can be subtracted from the reference current I0 but can also be added to the reference current I0. Therefore, slight adjustments for increasing or reducing the current I1, I2 flowing in the resistors R1, R2 can be performed. Thus, slight adjustments for increasing or decreasing the amount of the band gap reference voltage VBG can be easily performed. As a result, even if there is a variance of the band gap reference voltage VBG due to, for example, inconsistent manufacturing, the band gap reference voltage VBG can be easily corrected with high precision. Further, variance of the band gap reference voltage due to temperature can also be easily corrected with high precision.

Next, the configuration of the band gap reference circuit 20 is described in further detail.

The reference voltage generation circuit 23 includes an operational amplifier 21, a first series circuit having the resistor R1 and the transistor Q1 connected in series between an output terminal of the operation amplifier 21 and a first voltage for substrate and source (hereinafter referred to as “VSS1”), and a second series circuit having the resistor R2 and the transistor Q2 connected in series between the output terminal of the operational amplifier 21 and a second voltage for substrate and source (hereinafter referred to as “VSS2”). The first and second series circuits are connected to each other in parallel.

The transistors Q1, Q2 are diode-connected NPN bipolar transistors. The P-type region (base) of the transistor Q1 is connected to one end part of the resistor R1 toward a low potential side of the resistor R1 (hereinafter referred to as “low potential end part of the resistor R1”) whereas the P-type region (base) of the transistor Q2 is connected to one end part of the resistor R0 toward a low potential side of the resistor R0 (hereinafter referred to as “low potential end part of the resistor R0”). A forward bias voltage is applied to the PN junction between the base and the emitter of each of the transistors Q1 and Q2. Alternatively, the transistors Q1, Q2 may be diode-connected PNP bipolar transistors.

Further, the low potential end part of the resistor R1 and the P-type region (base) of the transistor Q1 are connected to a node n1. The node n1 is connected to a noninverting input terminal of the operational amplifier 21. Further, one end part of the resistor R2 toward a low potential side of the resistor R2 (hereinafter referred to as “low potential end part of the resistor R2”) and another end part of the resistor RO toward a high potential side of the resistor R0 (hereinafter referred to as “high potential end part of the resistor R0”) are connected to a node n2. The node n2 is connected to an inverting input terminal of the operational amplifier 21.

In this embodiment, a forward voltage of the PN junction between the base and the emitter of the transistor Q1 is indicated as “VBE1”, and a forward voltage of the PN junction between the base and the emitter of the transistor Q2 is indicated as “VBE2”. Accordingly, a voltage difference VBE1−VBE2 is applied to the resistor R0. By applying the voltage difference VBE1−VBE2 to the resistor R0, a constant reference current I0 which flows in the resistor R0 becomes set (defined). The currents I1, I2 flow in the resistors R1, R2 in correspondence with the reference current I0. Accordingly, a voltage having a positive temperature characteristic is generated in the resistors R1, R2. Therefore, a resistance value of the resistors R1, R2 can be selected, so that the negative temperature characteristics of the forward voltages VBE1, VBE2 of the transistors Q1, Q2 is set off (canceled) by the positive temperature characteristic of the voltage generated in the resistors R1, R2. By selecting the resistance values of the resistors R1, R2 that set off the negative temperature characteristics of the forward voltages VBE1, VBE2 of the transistors Q1, Q2 with respect to the positive temperature characteristic of the voltage generated in the resistors R1, R2, the band gap reference voltage VBG, exhibiting only a small amount of temperature dependency, can be output to the operational amplifier 21.

On the other hand, the correction current It generated by the correction circuit 22 is input and output at the node n2. Accordingly, the current I2, which flows through the resistor R2, can be expressed with the following Formula (4).

I2=I0−It (4)

The reference current I0 flowing in the resistor R0 and the PN junction between the base and the emitter of the transistor Q2 are maintained at a constant current by a negative feedback of the operational amplifier 21. Accordingly, by supplying the correction current It from the correction circuit 22 to the node n2, the current I2 is controlled to become the equivalent of subtracting the supplied correction current It from the reference current I0. Thus, the correction circuit 22 can allow the controlled current I2 to flow in the resistor R2. Therefore, the correction circuit 22 can reduce the current I2 by increasing the amount of correction current It supplied to the node n2 and increase the current I2 by reducing the amount of correction current It supplied to the node n2. Further, by absorbing the correction current It from the node n2, the current I2 is controlled to become the equivalent of adding the absorbed correction current It to the reference current I0. Thus, the correction circuit 22 can allow the controlled current I2 to flow in the resistor R2. Therefore, the correction circuit 22 can increase the current I2 by increasing the amount of correction current It absorbed from the node n2 and reduce the current I2 by reducing the amount of correction current It absorbed from the node n2. Hence, the current I2 is a correction reference current in which the correction current It is added/subtracted with respect to the reference current I0.

The current I1 flowing in the resistor R1 and the transistor Q1 can also be increased/reduced in correspondence with the increase/reduction of the current I2. Because the voltages generated in the resistors R1, R2 become larger as the currents I1, I2 increase, the band gap reference voltage VBG can be adjusted to a large degree. On the other hand, because the voltages generated in the resistors R1, R2 become smaller as the currents I1, I2 are reduced, the band gap reference voltage VBG can be adjusted to a small degree. Hence, the correction circuit 22, which can switch between supplying and absorbing of the correction current It, can easily correct the band gap reference voltage VBG with high precision by adjusting the amount of supplying the correction current It or the amount of absorbing the correction current It.

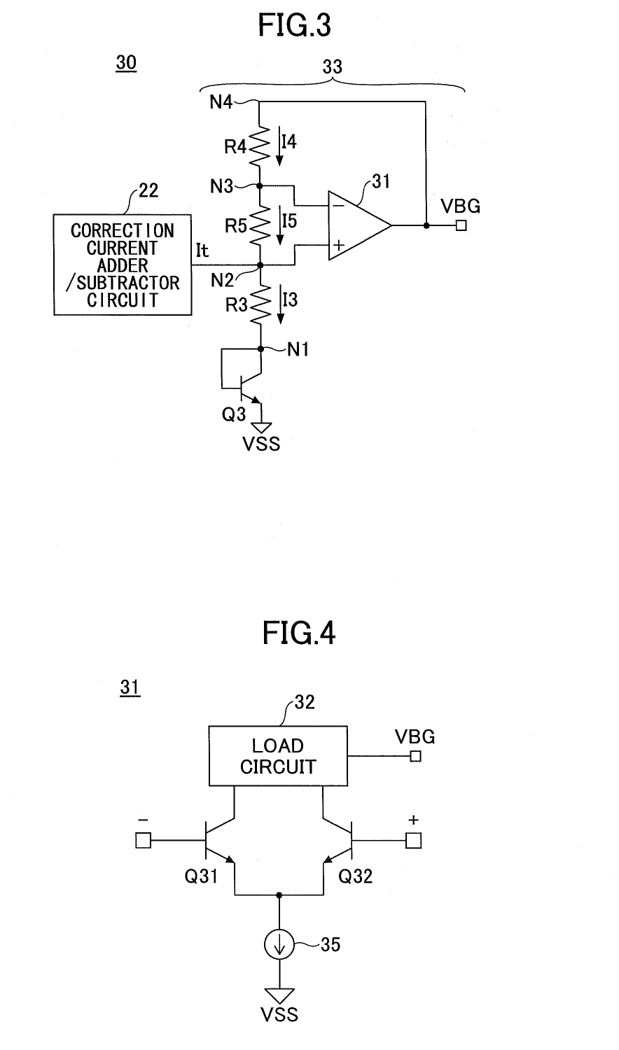

FIG. 3 is a schematic diagram illustrating a configuration of a band gap reference circuit 30 according to the second embodiment of the present invention. In the second embodiment, like components are denoted with like reference numerals as those of the first embodiment and are not further explained.

The band gap reference circuit 30 includes a reference voltage generation circuit 33 and a correction current adder/subtractor circuit (correction circuit) 22. The reference voltage generation circuit 33 includes an operational amplifier 31.

FIG. 4 is a schematic diagram illustrating a configuration of the operational amplifier 31.

The operational amplifier 31 includes a differential pair such as a pair of differential inputs operated with current densities that are different from each other. In this embodiment, the differential pair of differential inputs of the operational amplifier 31 is constituted by transistors Q31 and Q32. The base of the p-type region of the transistor Q31 is connected to an inverting input terminal of the operational amplifier 31. The base of the p-type region of the transistor Q32 is connected to a noninverting input terminal of the operational amplifier 31. The emitters of the n-type regions of the transistors Q31 and Q32 share a current source 35 and are connected to a voltage for substrate and source (VSS) by way of the shared current source 35. The transistors (differential pair) Q31, Q32 are connected to an output terminal of the operational amplifier 31 by way of a load circuit 32.

With the configuration illustrated in FIGS. 3 and 4, an input referred offset (VBE31−VBE32) of the operational amplifier 31 is generated in a case where the proportion (ratio) of the number of differential inputs between Q31 and Q32 (Q11:Q12) is set to 1:n, and the proportion (ratio) between the current of the differential input Q31 and the current of the differential input Q32 is set to m:1. As a result, the following Formula (5) is obtained.

VBE31−VBE32=Vt·1n (m·n) (5)

As illustrated in FIGS. 3 and 4, a voltage having a positive thermal characteristic is generated in the resistors R3, R4 by applying the input referred offset (VBE31−VBE32) to the resistor R5 interposed between the differential inputs Q31, Q32 of the operational amplifier 31. Therefore, a resistance value of the resistors R3, R4 can be selected, so that the negative temperature characteristics of the forward voltages VBE3 of the PN junction between the base and the emitter of the transistor Q3 is set off (canceled) by the positive temperature characteristic of the voltage generated in the resistors R3, R4, and R5. By selecting the resistance values of the resistors R3, R4 that set off the negative temperature characteristics of the forward voltages VBE3 of the PN junction between the base and the emitter of the transistor Q3 with respect to the positive temperature characteristic of the voltage generated in the resistors R3, R4, and R5, the band gap reference voltage VBG exhibiting only a small amount of temperature dependency can be output to the operational amplifier 31.

Accordingly, the reference voltage generation circuit 33 is a circuit that outputs the band gap reference voltage VBG based on a reference current I5 generated by the input referred offset (VBE31−VBE32). Further, the correction circuit 22 is a circuit that adds/subtracts the correction current It with respect to the reference current I5.

Hence, with the configuration illustrated in FIGS. 3 and 4, the correction current It not only can be subtracted from the reference current I5 but can also be added to the reference current I5. Therefore, slight adjustments for increasing or reducing the current I3 flowing in the resistor R3 can be performed. Accordingly, slight adjustments for increasing or reducing the amount of the band gap reference voltage VBG can be easily performed. As a result, even if there is a variance of the band gap reference voltage VBG due to, for example, inconsistent manufacturing, the band gap reference voltage VBG can be easily corrected with high precision. Further, variance of the band gap reference voltage due to temperature can also be easily corrected with high precision.

Next, the configuration of the band gap reference circuit 30 is described in further detail.

The band gap reference circuit 33 is a series circuit having the resistor R4, the resistor R5, and the resistor R3, and the transistor Q3 connected in series between the operational amplifier 31, an output terminal of the operational amplifier 31, and a voltage for substrate and source (VSS).

The transistor Q3 is a diode-connected NPN bipolar transistor. The p-type region (base) of the transistor Q3 is connected to one end part of the resistor R3 toward a low potential side of the resistor R3 (hereinafter referred to as “low potential end part of the resistor R3”). A forward bias voltage is applied to the PN junction between the base and the emitter of the transistor Q3. Alternatively, the transistor Q3 may be a diode-connected PNP bipolar transistor.

Further, one end part of the resistor R4 toward a low potential side of the resistor R4 (hereinafter referred to as “low potential end part of the resistor R4”) and one end part of the resistor R5 toward a high potential side of the resistor R5 (hereinafter referred to as “high potential end part of the resistor R5”) are connected to a node N3. The node N3 is connected to an inverting input terminal of the operational amplifier 31. The other end part of the resistor R5 toward a low potential side of the resistor R5 (hereinafter referred to as “low potential end part of the resistor R5”) and the other end part of the resistor R3 toward a high potential side of the resistor R3 (hereinafter referred to as “high potential end part of the resistor R3”) are connected to a node N2. The node N2 is connected to a noninverting input terminal of the operational amplifier 31.

The input referred offset (VBE31−VBE32) of the operational amplifier 31 is applied to the resistor R5. By applying the input referred offset (VBE31−VBE32) to the resistor R5, a constant reference current I5 which flows in the resistor R5 becomes set (defined). The currents I3, I4 flow in the resistors R3, R4 in correspondence with the reference current I5. Accordingly, a voltage having a positive temperature characteristic is generated in the resistors R3, R4. Therefore, a resistance value of the resistors R3, R4 can be selected, so that the negative temperature characteristic of the forward voltage VBE3 of the transistor Q3 is set off (canceled) by the positive temperature characteristic of the voltage generated in the resistors R3, R4. By selecting the resistance value of the resistors R3, R4 that sets off the negative temperature characteristic of the forward voltage VBE3 of the transistor Q3 with respect to the positive temperature characteristic of the voltage generated in the resistors R3, R4, the band gap reference voltage VBG, exhibiting only a small amount of temperature dependency, can be output from the operational amplifier 31.

On the other hand, the correction current It generated by the correction circuit 22 is input and output at the node N2. Accordingly, the current I3, which flows through the resistor R3, can be expressed with the following Formula (6).

I3=I5+It (6)

The current I3 flows through the resistor R3 and the PN junction between the base and the emitter of the transistor Q3.

The reference current I5 flowing in the resistor R5 is maintained at a constant current by a negative feedback of the operational amplifier 31. Accordingly, by supplying the correction current It from the correction circuit 22 to the node N2, the current I5 is controlled to become the equivalent of adding the supplied correction current It to the reference current I5. Thus, the correction circuit 22 can allow the controlled current I3 to flow in the resistor R3. Therefore, the correction circuit 22 can increase the current I3 by increasing the amount of correction current It supplied to the node N2 and reduce the current I3 by reducing the amount of correction current It supplied to the node N2. Further, by absorbing the correction current It from the node N2, the current I3 is controlled to become the equivalent of subtracting the absorbed correction current It from the reference current I5. Thus, the correction circuit 22 can allow the controlled current I3 to flow in the resistor R3. Therefore, the correction circuit 22 can reduce the current I3 by increasing the amount of correction current It absorbed from the node N2 and increase the current I3 by reducing the amount of correction current It absorbed from the node N2. Hence, the current I3 is a correction reference current in which the correction current It is added/subtracted with respect to the reference current I5.

The current flowing in the transistor Q3 can also be increased/reduced in correspondence with the increase/reduction of the current I3. Because the voltages generated in the resistor R3 becomes larger as the current I3 increases, the band gap reference voltage VBG can be adjusted to a large degree: On the other hand, because the voltage generated in the resistor R3 become smaller as the current I3 is reduced, the band gap reference voltage VBG can be adjusted to a small degree. Hence, the correction circuit 22, which can switch between supplying and absorbing of the correction current It, can easily correct the band gap reference voltage VBG with high precision by adjusting the amount of supplying the correction current It or the amount of absorbing the correction current It.

As described above, the band gap reference circuit 30 of the second embodiment has the reference voltage generation circuit 33 serving as a first circuit (first system) including a combination of transistors and resistors for generating the band gap reference voltage VBG, and the correction circuit 22 for adding/subtracting the correction current It with respect to the reference voltage I0 flowing in the first circuit. With this configuration, the sensitivity for adjusting the band gap reference voltage VBG to increase matches with the sensitivity for adjusting the band gap reference voltage VBG to decrease. Therefore, the amount of current for correcting the band gap reference voltage VBG can easily be obtained (calculated) based on the band gap reference voltage VBG which is measured prior to the current correction using the correction current It.

Further, by setting the combination of transistors and resistors for generating the band gap reference voltage VBG as the first circuit, current consumption can be reduced and noise can be lowered.

Further, the changes (variance) of the output band gap reference voltage VBG can be stabilized with the correction circuit 22. For example, in a case of calculating the amount of voltage change of the band gap reference voltage VBG where the unit of adjusting the correction current Vt in each adjustment step is assumed as a % with respect to the reference current I5 and the correction current Vt is adjusted in b step(s), the results obtained when the correction current It is supplied to the node N2 are as follows:

Voltage VR5 generated in the resistor R5:

VR5=VBE31−VBE 32=Vt·1n(m·n);

Voltage VR3 generated in the resistor R3:

VR3=VR5·(R3/R5);

Amount of voltage change ΔVR3 of voltage VR3 when the correction current It of +a %×b step(s) is added to the resistor R3:

ΔVR3=VR5·(R3/R5)·a/100·b;

Amount of voltage change ΔVQ3 between the base and the emitter of the transistor Q3 when the correction current It of +a %×b step(s) is added to the transistor Q3:

ΔVQ3=Vt·1n (1+a/100×b)

(for example, ΔVQ3 becomes 0.00995·Vt in a case where b=1 and a=1%, and ΔVQ3 becomes 0.0198·Vt in a case where b=1 and a=2%); and
Amount of voltage change ΔVBGR of the band gap reference voltage VBG:

ΔVBGR=ΔVR3+ΔVQ3=VR5·(R3/R5)·a/100·b+Vt·1n (1+a/100×b).

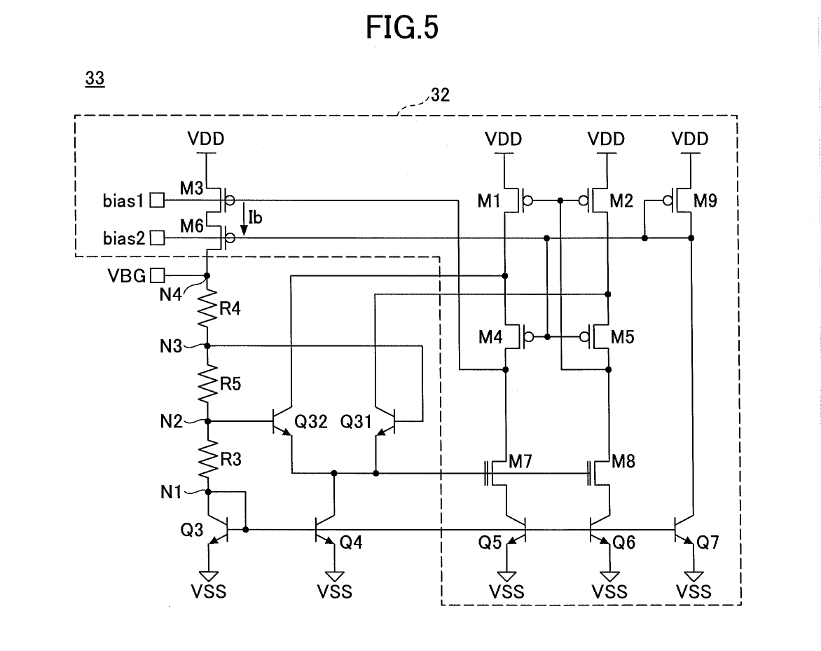

FIG. 5 is a schematic diagram illustrating an example of a configuration of the reference voltage generation circuit 33. It is to be noted that the load circuit 32 of FIG. 4 corresponds to the area illustrated with broken lines in FIG. 5.

In FIG. 5, by setting a proportion (ratio) of the current between the pair of differential inputs Q31 and Q32 to m:1, it is preferable for the proportion (ratio) of the current between the transistors to be Q31:Q32:Q4:Q5:Q6:M1:M2=m:1:(m+1):1:m:2:2m.

The transistors M6, M7, and M8 are added to the reference voltage generation circuit 33 for improving the output resistance of the operational amplifier 31. However, the transistors M6, M7, and M8 may be omitted from the reference voltage generation circuit 33. In an alterative configuration, the transistors M4, M5, M6, M7, M8, M9, and Q7 may be omitted from the reference voltage generation circuit 33, the load circuit of the pair of differential inputs Q31 and Q32 may be used as transistors M1, M2, and the transistor M3 may be used as an output buffer.

The input/output point of the correction current It for correcting the band gap reference voltage VBG may be the node N3, the node N2, or the node N1. Further, in a case where the resistors R3 and R4 are divided into multiple resistor elements, an intermediate point(s) between the multiple resistor elements may be the input/output point of the correction current It for correcting the band gap reference voltage VBG.

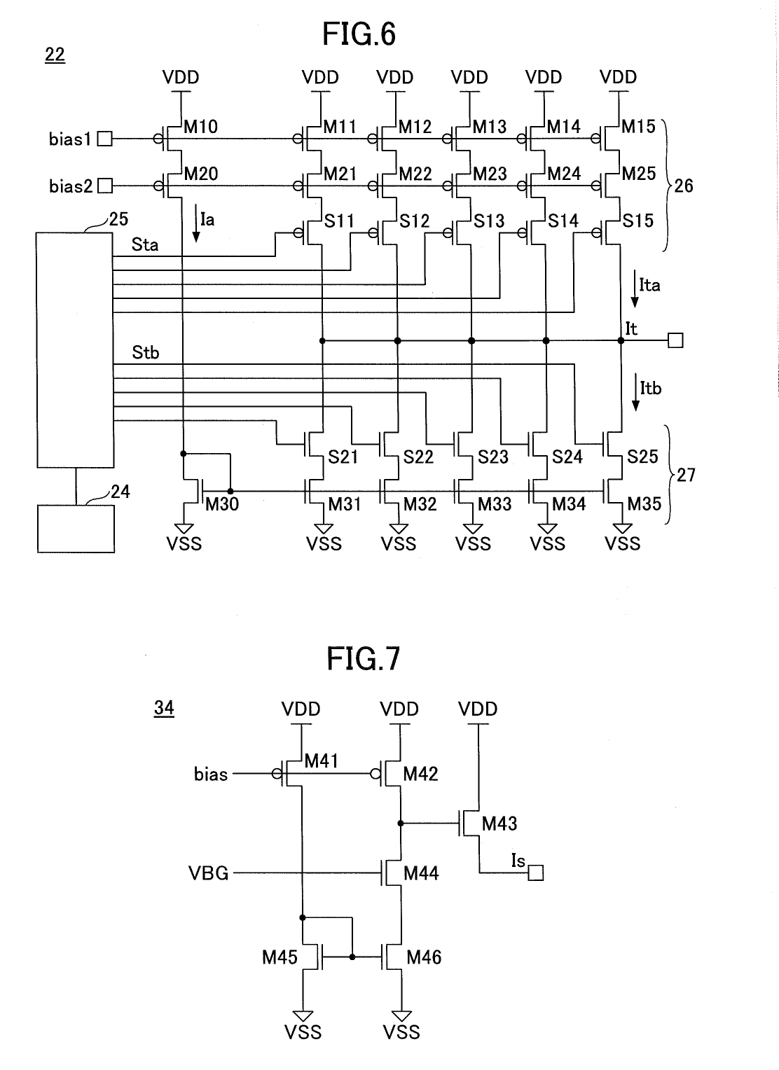

FIG. 6 is a schematic diagram illustrating an example of a configuration of the correction circuit 22. In a case where the correction circuit 22 is used in the band gap reference circuit 20 illustrated in FIG. 2, the correction circuit 22 includes a current absorbing circuit 27 for generating an absorbing current Itb and a current supplying circuit 26 for generating a supplying current Ita. In this case, the current absorbing circuit 27 serves as a first generation circuit of the correction circuit 22 for generating a first correction current that is to be added to the reference current I0, and the current supplying circuit 26 serves as a second generation circuit of the correction circuit 22 for generating a second correction current that is to be subtracted from the reference current I0. In a case where the correction circuit 22 is used in the band gap reference circuit 30 illustrated in FIG. 3, the correction circuit 22 includes the current supplying circuit 26 for generating a supplying current Ita and the current absorbing circuit 27 for generating an absorbing current Itb. In this case, the current supplying circuit 26 serves as a first generation circuit of the correction circuit 22 for generating a first correction current that is to be added to the reference current I0, and the current absorbing circuit 27 serves as a second generation circuit of the correction circuit 22 for generating a second correction current that is to be subtracted from the reference current I0. The correction current It is a combined current obtained by combining the supplying current Ita and the absorbing current Itb.

That is, the current supplying circuit 26 is an upstream current source for generating the correction current It and the current absorbing circuit 27 is a downstream current source for generating the correction current It.

The correction circuit 22 includes a control circuit 25 for outputting correction control signals Sta, Stb to the current supplying circuit 26 and the current absorbing circuit 27 in correspondence with adjustment data for adjusting the amount of increasing/reducing the correction current It. The control circuit 25 controls the amount in which the correction current It is increased or reduced by outputting the correction control signals Sta, Stb to the current supplying circuit 26 and the current absorbing circuit 27. The control circuit 25 may be configured as a logical circuit or as a microcomputer.

The adjustment data of the correction current It is stored in, for example, a non-volatile memory 24. The non-volatile memory 24 may be, for example, an EEPROM (Electrically Erasable Programmable Read Only Memory), a flash ROM (Read Only Memory), or a OTPROM (One Time Programmable Read Only Memory).

By changing the adjustment data of the correction current It, the unit of adjusting the amount of the correction current It (unit adjustment range) can be adjusted. For example, the control circuit 25 can use the correction control signals Sta, Stb to increase or reduce the correction current It by weighting in binary. Accordingly, even in a case where the number of transistors M*, S* included in the current supplying circuit 26 and the current absorbing circuit 27 is small, the unit of adjusting the amount of the correction current It can be reduced. The smaller the unit of adjusting the amount of the correction current It, the smaller the unit adjustment range of the band gap reference voltage VBG can be reduced. Therefore, the band gap reference voltage VBG can be adjusted with high precision. Further, the control circuit 25 may control the increasing or reduction of the correction current It in accordance with a thermometer code.

Further, the correction circuit 22 can generate the correction current It based on a bias current Ib (see, for example, FIG. 5) that is supplied for generating the band gap reference voltage VBG. The bias current Ib is supplied from output buffers (transistors) M3 and M6. The output buffers M3 and M6 are positioned upstream of a node N4 from which the band gap reference voltage VBG is output. In FIG. 5, bias 1 and bias 2 are connected to transistors M3 and M6, and a generation reference voltage Ia of the correction current It is generated by copying the bias current Ib with the transistors M3 and M6. Likewise, in FIG. 6, bias 1 and bias 2 are connected to transistors M10 and M20, and a generation reference voltage Ia of the correction current It is generated by copying the bias current Ib with the transistors M10 and M20. In order to attain a precise unit adjustment amount of the correction current It, the bias current Ib is copied so that the generation reference current Ia is a value lower than the bias current Ib.

By copying the bias current Ib (which is supplied for obtaining the band gap reference voltage VBG) and correcting the bias voltage Ib, the amount of adjusting the correction voltage per unit correction step can easily be obtained. Therefore, by measuring the band gap reference voltage VBG, the number of steps for adjusting voltage can easily be obtained, and the number of steps performed in the voltage adjustment can be reduced.

Further, unlike correcting the resistance value, there is no need to use transistors M* or switches S* (see, for example, FIG. 6) exhibiting a sufficiently small amount of on-resistance with respect to the resistors R3, R4, and R5 (see, for example, FIG. 5) because correction is performed by applying current. Therefore, size reduction (area reduction) of the band gap reference circuit 20,30 can be achieved. Because the power source voltage VDD has little influence on the on-resistance of the transistors M* and the switches S* constituting the current supplying circuit 26 or the current absorbing circuit 27, changes of the band gap reference voltage VBG due to the power source voltage VDD can be reduced.

FIG. 7 is a schematic diagram illustrating an example of a configuration of a startup circuit 34 for activating (starting up) a band gap reference circuit according to an embodiment of the present invention. The startup circuit 34 turns on/off the output of a startup current Is in correspondence with the band gap reference voltage VBG. In a case where the band gap reference voltage VBG is less than a predetermined value, the startup circuit 34 switches on the startup current Is. In a case where the band gap reference voltage VBG is greater than the predetermined value, the startup circuit 34 switches off the startup current Is.

In a case of the configuration illustrated in FIG. 2, it is preferable to supply the startup current Is to a given node interposed between the node n1 and the node n4. In a case of the configuration illustrated in FIG. 3, it is preferable to supply the startup current Is to a given node interposed between the node N4 and the node N1.

In FIG. 7, when the band gap reference voltage VBG is less than a gate threshold voltage of an NMOS transistor M44 of a source follower, the transistor M44 switches off the output of a current source M46 toward a N-channel MOS. Thereby, the startup current Is is output because the gate voltage of an NMOS transistor M43 toward the N-channel MOS of a startup source follower increases. On the other hand, when the band gap reference voltage VBG is greater than the gate threshold voltage of the NMOS transistor M44, the transistor M44 switches on the output of the current source M46. Thereby, the startup current Is is automatically switched off because the gate voltage of the NMOS transistor M43 decreases. Therefore, it is preferable for the size of the transistors M41, M42, M45, and M46 to be adjusted beforehand, so that a current performance (ability) of the current source M46 is greater than the current source M42 toward the PMOS. With the configuration of the circuit of FIG. 7, a startup circuit having a simple configuration including a source follower for detecting voltage and a source follower for applying current can be obtained and size reduction of the band gap reference circuit 20,30 can be achieved.

Further, the present invention is not limited to these embodiments, but variations and modifications may be made without departing from the scope of the present invention.

For example, a fuse element may be used instead of the switch S* of the correction circuit 22 of FIG. 6.

The present application is based on Japanese Priority Application No. 2012-057886 filed on Mar. 14, 2012, with the Japanese Patent Office, the entire contents of which are hereby incorporated by reference.

What is claimed is:

1. A band gap reference circuit comprising:
an output circuit configured to output a reference voltage based on a reference current generated by a voltage difference between a forward voltage of a PN junction of a first semiconductor device and a forward voltage of a PN junction of a second semiconductor device; and
a adder/subtractor circuit configured to add or subtract a correction current with respect to the reference current.

2. The band gap reference circuit as claimed in claim 1, wherein the first and the second semiconductor devices constitute a differential pair.

3. The band gap reference circuit as claimed in claim 2, wherein the output circuit includes a first resistor interposed between the differential pair.

4. The band gap reference circuit as claimed in claim 3,
wherein the output circuit includes a second resistor through which a corrected reference current flows, and a PN junction part through which the corrected reference current flows, and
wherein the corrected reference current is an equivalent of subtracting the correction current from the reference current or adding the correction current to the reference current.

5. The band gap reference circuit as claimed in claim 1,
wherein the output circuit includes
a first resistor to which the voltage difference is applied,
a second resistor through which a corrected reference current flows, and
a PN junction part through which the corrected reference current flows,
wherein the corrected reference current is an equivalent of subtracting the correction current from the reference current or adding the correction current to the reference current.

6. The band gap reference circuit as claimed in claim 4, wherein the first resistor, the second resistor, and the PN junction part are connected in series.

7. The band gap reference circuit as claimed in claim 5, wherein the first resistor, the second resistor, and the PN junction part are connected in series.

8. The band gap reference circuit as claimed in claim 1,
wherein a bias current that is to be used for generating the reference voltage is supplied to the adder/subtractor circuit, and
wherein the adder/subtractor circuit is configured to generate the correction current based on the bias current.

9. The band gap reference circuit as claimed in claim 1, wherein the adder/subtractor circuit is configured to increase or reduce the correction current in correspondence with adjustment data of the correction current.

10. The band gap reference circuit as claimed in claim 9, wherein the adder/subtractor circuit includes a memory configured to store the adjustment data.

11. The band gap reference circuit as claimed in claim 1, wherein the adder/subtractor circuit is configured to increase or reduce the correction current by weighting in binary.

12. The band gap reference circuit as claimed in claim 1, wherein the adder/subtractor circuit includes
a first generation circuit configured to generate a first correction current that is added to the reference current, and
a second generation circuit configured to generate a second correction current that is subtracted from the reference current.

13. The band gap reference circuit as claimed in claim 12, wherein one of the first and the second generation circuits is a current supplying circuit and the other of the first and the second generation circuits is a current absorbing circuit.
